(19) United States
(12) Patent Application Publication
(10) Pub. No.: US 2026/0178831 A1
(43) Pub. Date: Jun. 25, 2026

(54) DOCUMENT CLASSIFICATION APPARATUS, DOCUMENT CLASSIFICATION METHOD, AND STORAGE MEDIUM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 18/729,931

(22) PCT Filed: Jan. 25, 2022
(86) PCT No.: PCT/JP2022/002595

§ 371 Date: Jul. 18, 2024

(51) Int. Cl. G06F 40/279; G06F 40/40

(52) U.S. Cl. CPC G06F 40/279; G06F 40/40

(57) ABSTRACT

In order to classify, stably with high accuracy, a document to be classified, a document classification apparatus (1) includes: a hypothetical sentence generation section (11) that generates, for a candidate classification as which a document is to be classified, a plurality of hypothetical sentences, which are sentences related to the candidate classification; an entailment evaluation section (12) that subjects each of the plurality of hypothetical sentences to a process for evaluating whether the document entails a corresponding hypothetical sentence; and an evaluation result aggregation section (13) that determines, on the basis of a result of evaluation of each of the plurality of hypothetical sentences by the entailment evaluation section (12), a classification as which the document is to be classified.

### TECHNICAL FIELD

The present invention relates to, for example, a document classification apparatus that automatically classifies a document.

### BACKGROUND ART

A large amount of data of various contents has recently been collected and accumulated. This requires a technique for automatically classifying such data. For example, Non-patent Literature 1 below discloses a technique for automatically associating a label with text by a method called zero-shot classification.

More specifically, according to the technique of Non-patent Literature 1, first, a premise sentence is generated from text to be classified, and a hypothetical sentence related to a label of a candidate classification is also generated. Then, by inputting the generated premise sentence and the generated hypothetical sentence into an entailment model, a degree to which the label matches the text to be classified is determined. The entailment model is a model constructed by machine learning whether a premise sentence entails a hypothetical sentence, i.e., whether the premise sentence includes the same content as the hypothetical sentence.

### CITATION LIST

### Non-Patent Literature

### [Non-Patent Literature 1]

Wenpeng Yin, Jamaal Hay, Dan Roth, “Benchmarking Zero-shot Text Classification: Datasets, Evaluation and Entailment Approach”, arXiv: 1 909.00161v1 [cs. CL], Aug. 31, 2019

### SUMMARY OF INVENTION

### Technical Problem

In the technique of Non-patent Literature 1, determination accuracy is affected depending on what a hypothetical sentence corresponding to each label is like, and there is room for improvement in accuracy and stability of classification. For example, regarding a label “sport”, a case where a hypothetical sentence “This is a sentence concerning sport.” is generated and a case where a hypothetical sentence “This refers to a topic of sport.” is generated differ in output value from an entailment model. Thus, even the same label “sport” results in different results of determination of a matching degree depending on which hypothetical sentence is generated.

An example aspect of the present invention has been made in view of such a problem, and an example object thereof is to provide a technique that makes it possible to classify, stably with high accuracy, a document to be classified.

### Solution to Problem

A document classification apparatus according to an example aspect of the present invention includes: a hypothetical sentence generation means that generates, for a candidate classification as which a document is to be classified, a plurality of hypothetical sentences, which are sentences related to the candidate classification; an entailment evaluation means that subjects each of the plurality of hypothetical sentences to a process for evaluating whether the document entails a corresponding hypothetical sentence; and an evaluation result aggregation means that determines, on the basis of a result of evaluation of each of the plurality of hypothetical sentences by the entailment evaluation means, a classification as which the document is to be classified.

A document classification method according to an example aspect of the present invention includes: (a) generating, for a candidate classification as which a document is to be classified, a plurality of hypothetical sentences, which are sentences related to the candidate classification; (b) subjecting each of the plurality of hypothetical sentences to a process for evaluating whether the document entails a corresponding hypothetical sentence; and (c) determining, on the basis of a result of evaluation of each of the plurality of hypothetical sentences, a classification as which the document is to be classified, (a), (b), and (c) each being carried out by at least one processor.

A document classification program according to an example aspect of the present invention causes a computer to function as: a hypothetical sentence generation means that generates, for a candidate classification as which a document is to be classified, a plurality of hypothetical sentences, which are sentences related to the candidate classification; an entailment evaluation means that subjects each of the plurality of hypothetical sentences to a process for evaluating whether the document entails a corresponding hypothetical sentence; and an evaluation result aggregation means that determines, on the basis of a result of evaluation of each of the plurality of hypothetical sentences by the entailment evaluation means, a classification as which the document is to be classified.

### Advantageous Effects of Invention

An example aspect of the present invention makes it possible to classify, stably with high accuracy, a document to be classified.

### BRIEF DESCRIPTION OF DRAWINGS

FIG. 1 is a block diagram illustrating a configuration of a document classification apparatus according to a first example embodiment of the present invention.

FIG. 2 is a flowchart showing a flow of a document classification method according to the first example embodiment of the present invention.

FIG. 3 is a view illustrating an example of classification of a document by a document classification method according to a second example embodiment of the present invention.

FIG. 4 is a block diagram illustrating a configuration of a document classification apparatus according to the second example embodiment of the present invention.

FIG. 5 is a view illustrating an example of a generation strategy.

FIG. 6 is a view illustrating a method for generating a language understanding model.

FIG. 7 is a view illustrating examples of a method for calculating reliability of a generation strategy and a method for calculating an aggregate score with use of reliability.

FIG. 8 is a flowchart showing a flow of a process carried out by the document classification apparatus.

FIG. 9 is a view illustrating an example of a computer that executes instructions of a program that is software realizing functions of apparatuses according to example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for example embodiments described later.

### (Configuration of Document Classification Apparatus)

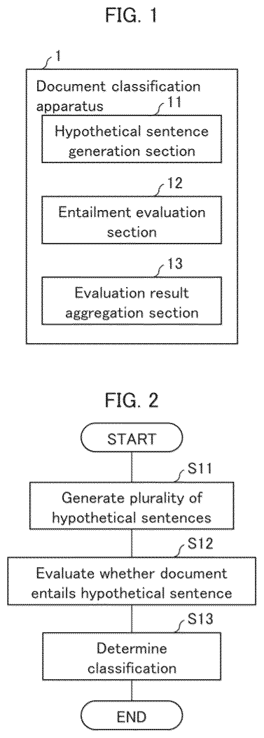

The following description will discuss, with reference to FIG. 1, a configuration of a document classification apparatus 1 according to the present example embodiment. FIG. 1 is a block diagram illustrating the configuration of the document classification apparatus 1. The document classification apparatus 1 includes a hypothetical sentence generation section 11, an entailment evaluation section 12, and an evaluation result aggregation section 13 as illustrated in FIG. 1.

The hypothetical sentence generation section 11 generates, for a candidate classification as which a document is to be classified, a plurality of hypothetical sentences, which are sentences related to the candidate classification.

The entailment evaluation section 12 subjects each of the plurality of hypothetical sentences to a process for evaluating whether the document entails a corresponding hypothetical sentence.

The evaluation result aggregation section 13 determines, on the basis of a result of evaluation of each of the plurality of hypothetical sentences by the entailment evaluation section 12, a classification as which the document is to be classified.

As described above, a configuration is employed such that the document classification apparatus 1 according to the present example embodiment includes: the hypothetical sentence generation section 11 that generates, for a candidate classification as which a document is to be classified, a plurality of hypothetical sentences, which are sentences related to the candidate classification; the entailment evaluation section 12 that subjects each of the plurality of hypothetical sentences to a process for evaluating whether the document entails a corresponding hypothetical sentence; and the evaluation result aggregation section 13 that determines, on the basis of a result of evaluation of each of the plurality of hypothetical sentences by the entailment evaluation section 12, a classification as which the document is to be classified. This configuration makes it possible to classify, stably with high accuracy, a document to be classified.

### (Document Classification Program)

The foregoing functions of the document classification apparatus 1 can also be realized by a program. A document classification program according to the present example embodiment causes a computer to function as: a hypothetical sentence generation means that generates, for a candidate classification as which a document is to be classified, a plurality of hypothetical sentences, which are sentences related to the candidate classification; an entailment evaluation means that subjects each of the plurality of hypothetical sentences to a process for evaluating whether the document entails a corresponding hypothetical sentence; and an evaluation result aggregation means that determines, on the basis of a result of evaluation of each of the plurality of hypothetical sentences by the entailment evaluation means, a classification as which the document is to be classified. This document classification program makes it possible to classify, stably with high accuracy, a document to be classified.

### (Flow of Document Classification Method)

The following description will discuss, with reference to FIG. 2, a flow of a document classification method according to the present example embodiment. FIG. 2 is a flowchart showing the flow of the document classification method. Note that steps of this document classification method may be carried out by a processor of the document classification apparatus 1 or by a processor of another apparatus. Alternatively, the steps may be carried out by processors provided in respective different apparatuses.

In S11, at least one processor generates, for a candidate classification as which a document is to be classified, a plurality of hypothetical sentences, which are sentences related to the candidate classification.

In S12, the at least one processor subjects each of the plurality of hypothetical sentences to a process for evaluating whether the document entails a corresponding hypothetical sentence.

In S13, the at least one processor determines, on the basis of a result of evaluation of each of the plurality of hypothetical sentences, a classification as which the document is to be classified.

As described above, a document classification method according to the present example embodiment includes: (a) generating, for a candidate classification as which a document is to be classified, a plurality of hypothetical sentences, which are sentences related to the candidate classification; (b) subjecting each of the plurality of hypothetical sentences to a process for evaluating whether the document entails a corresponding hypothetical sentence; and (c) determining, on the basis of a result of evaluation of each of the plurality of hypothetical sentences, a classification as which the document is to be classified, (a), (b), and (c) each being carried out by at least one processor. This document classification method makes it possible to classify, stably with high accuracy, a document to be classified.

### Second Example Embodiment

The following will discuss a second example embodiment of the present invention in detail with reference to the drawings.

### (Overview of Document Classification Method)

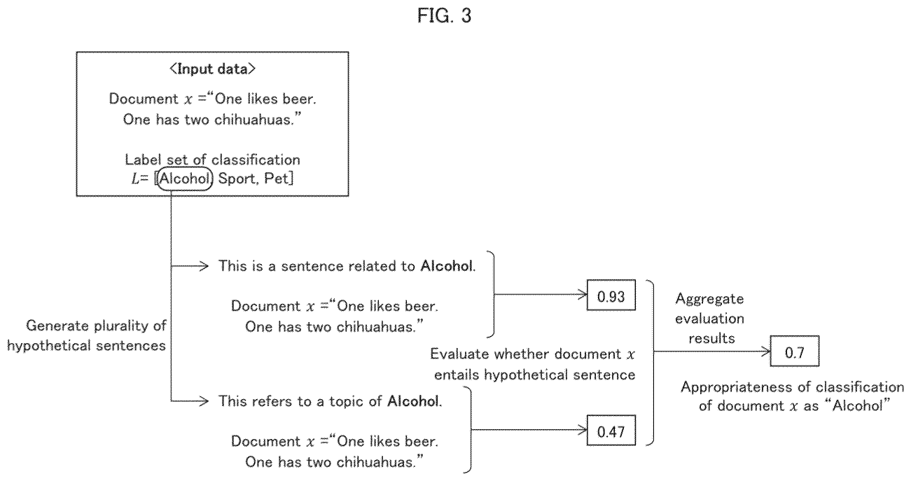

The following description will discuss, with reference to FIG. 3, an overview of a document classification method according to the present example embodiment (hereinafter referred to as the present method). FIG. 3 is a view illustrating an example of classification of a document by the present method. As illustrated in the drawing, in the example of FIG. 3, a document x and a label set L of a classification are given as input data.

Note that the classification can also be called a topic and that classification of the document x can also be referred to as a process for estimating a topic of the document x. Further, in a case where the document x is extracted from a conversation sentence and the label set L is a set of labels indicating an emotion of a speaker, classification of the document x can be rephrased as estimation of the emotion of the speaker. Furthermore, in a case where the label set L is a set of labels indicating a situation, classification of the document x can also be rephrased as estimation of the situation indicated by the document x.

The document x is a document to be classified, and is specifically text data “One likes beer. One has two Chihuahuas.” The label set L indicates a candidate classification as which the document x is to be classified. The label set L illustrated in FIG. 3 includes three candidates, i.e., alcohol, sport, and a pet. In FIG. 3, it is evaluated whether “alcohol” among these candidates is appropriate as a classification as which the document x is to be classified.

In the present method, for a candidate classification as which the document x is to be classified, a plurality of hypothetical sentences related to the candidate classification are generated. In the example of FIG. 3, text data “This is a sentence related to alcohol.” and text data “This refers to a topic of alcohol.” are generated as hypothetical sentences related to “alcohol”.

Next, in the present method, a process for evaluating entailment between a hypothetical sentence and a document is carried out with respect to each of the plurality of hypothetical sentences. In the example of FIG. 3, it is evaluated whether the document x to be classified, i.e., “One likes beer. One has two Chihuahuas.” entails the hypothetical sentence “This is a sentence related to alcohol.”, and an evaluation result of 0.93 is obtained. Further, similarly, it is evaluated whether the document x entails the hypothetical sentence “This refers to a topic of alcohol.”, an evaluation result of 0.47 is obtained.

Though details will be discussed in “Language understanding model” described later, these numerical values each indicate a degree to which the document x entails a corresponding hypothetical sentence, and a value closer to 1 means that the degree is higher. Such a numerical value is hereinafter referred to as an entailment score. Note that the degree to which the document x entails the hypothetical sentence can be rephrased as a degree of possibility that the document entails the hypothetical sentence. Note also that the degree to which the document x entails the hypothetical sentence can be alternatively rephrased as a degree of possibility that the content of the hypothetical sentence is correct when the document x is regarded as a premise sentence.

In a case where the hypothetical sentence and the document x to be classified contain the same meaning, or in a case where it can be said that the content of the hypothetical sentence is correct when the document x is regarded as the premise sentence, it can be said that a candidate classification related to the hypothetical sentence is highly likely to match the document to be classified. Thus, it can also be said that the entailment score indicates appropriateness of classification of the document to be classified as the candidate classification.

For example, the hypothetical sentence “This is a sentence related to alcohol.” and the document x to be classified have an entailment score of 0.93. The entailment score of 0.93 is close to its maximum value of 1. Thus, this entailment score indicates that the document x is highly likely to entail the above hypothetical sentence. This entailment score also indicates that it is highly appropriate to classify the document x as the candidate classification “alcohol” on which the hypothetical sentence “This is a sentence related to alcohol.” is based.

In contrast, a lower entailment score of 0.47 is calculated for the hypothetical sentence “This is a sentence related to alcohol.” that has been generated also from the candidate classification “alcohol”. As described above, the entailment score to be calculated may vary depending on a generated hypothetical sentence even in a case where a combination of the document x to be classified and the candidate classification is unchanged.

Thus, in the present method, results of evaluation of the respective plurality of hypothetical sentences generated as described earlier are aggregated to evaluate appropriateness of classification of the document x to be classified as the candidate classification. In the example of FIG. 3, an arithmetic mean of the calculated entailment scores of 0.93 and 0.47 is calculated as a numerical value indicating appropriateness of classification of the document x as “alcohol” (hereinafter referred to as “aggregate score”). This makes it possible to stably obtain a highly accurate evaluation result for appropriateness, as compared with a case where only one hypothetical sentence is generated.

It is possible to properly classify the document x by carrying out the above-described process with respect to each of candidate classifications included in the label set L. For example, a candidate that has an aggregate score which exceeds a preset threshold may be automatically determined as a classification. Alternatively, a display apparatus or the like may be caused to output an aggregate score of each of candidates so as to allow a user to select a candidate to be employed as a classification as which the document x is to be classified. Note that a plurality of classifications may be determined for one document. For example, two classifications, i.e., “alcohol” and “pet” may be determined for the document x in FIG. 3.

A determined classification need only be recorded in association with the document x. The document x with which information indicating a classification is associated is more widely used and utilized, for example such that it is possible to carry out, for example, search with use of the classification. Further, the document x with which the information indicating a classification is associated can also be used as training data for machine learning a classification as which a document is to be classified.

### (Configuration of Document Classification Apparatus)

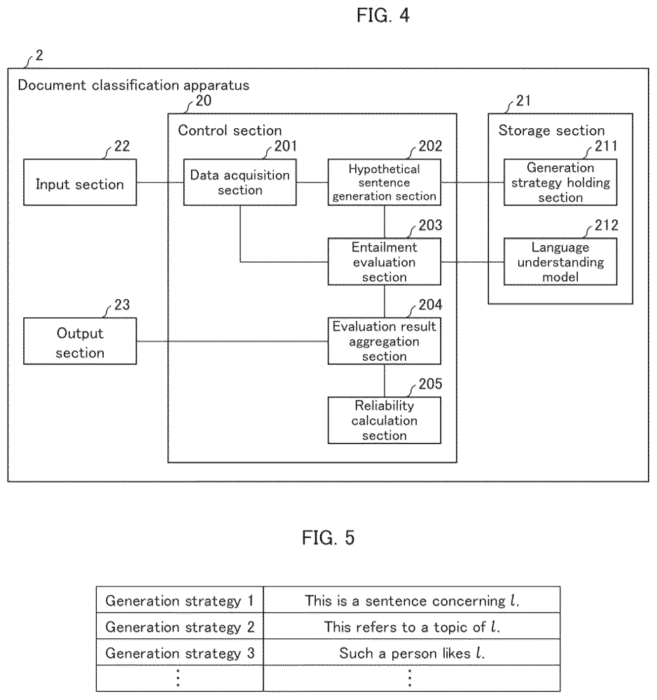

The following description will discuss, with reference to FIG. 4, a configuration of a document classification apparatus 2 according to the present example embodiment. FIG. 4 is a block diagram illustrating the configuration of the document classification apparatus 2. The document classification apparatus 2, which is an apparatus for classifying a document, includes, as illustrated in the drawing, a control section 20 that collectively controls sections of the document classification apparatus 2 and a storage section 21 that stores various kinds of data used by the document classification apparatus 2. The document classification apparatus 2 also includes an input section 22 that receives an input operation carried out by a user with respect to the document classification apparatus 2 and an output section 23 that allows the document classification apparatus 2 to output data. Note that the document classification apparatus 2 may be a dedicated apparatus for classification of a document or a general-purpose apparatus that can be used for applications other than classification of a document.

The control section 20 includes a data acquisition section 201, a hypothetical sentence generation section (hypothetical sentence generation means) 202, an entailment evaluation section (entailment evaluation means) 203, an evaluation result aggregation section (evaluation result aggregation means) 204, and a reliability calculation section 205. The storage section 21 includes a generation strategy holding section 211 and stores a language understanding model 212. Note that the reliability calculation section 205 will be in discussed “Evaluation in consideration of reliability” described later.

The data acquisition section 201 acquires a document to be classified. The data acquisition section 201 also acquires a candidate classification as which the document is to be classified. For example, the data acquisition section 201 may acquire, as the document to be classified, text data that has been input via the input section 22, and may acquire, as the candidate classification, a label set that has been input also via the input section 22.

The hypothetical sentence generation section 202 generates, for a candidate classification as which a document is to be classified, a plurality of hypothetical sentences, which are sentences related to the candidate classification. More specifically, the hypothetical sentence generation section 202 uses a generation strategy stored in the generation strategy holding section 211 of the storage section 21 to generate a hypothetical sentence from the candidate classification that has been acquired by the data acquisition section 201. A method for generating a hypothetical sentence with use of a generation strategy will be discussed in “Generation strategy” described later.

The entailment evaluation section 203 subjects each of the plurality of hypothetical sentences to a process for evaluating whether the document to be classified entails a corresponding hypothetical sentence. More specifically, the entailment evaluation section 203 inputs, into the language understanding model 212 stored in the storage section 21, a set of a hypothetical sentence and a document which set is to be evaluated, and calculates an entailment score, which is an index value indicating a degree to which the input document entails the input hypothetical sentence. The language understanding model 212 will be discussed in detail in “Language understanding model” described later.

The evaluation result aggregation section 204 determines, on the basis of a result of evaluation of each of the plurality of hypothetical sentences by the entailment evaluation section 203, a classification as which the document to be classified is to be classified. More specifically, the evaluation result aggregation section 204 aggregates entailment scores calculated for the respective plurality of hypothetical sentences, calculates an aggregate score indicating an evaluation result for appropriateness of classification of the document to be classified as a candidate classification, and uses this aggregate score to determine a classification. Note that the aggregate score can be said to indicate a classification as which the document to be classified is to be classified. Thus, the evaluation result aggregation section 204 may output the aggregate score as information indicating the classification as which the document to be classified is to be classified.

A method of calculating the aggregate score is not particularly limited provided that the method is such a method which allows the aggregate score in which at least some of the calculated entailment scores are reflected to be calculated. For example, in a case where the entailment evaluation section 203 uses the language understanding model 212 to calculate an entailment score, which is an index value indicating a degree to which the document to be classified entails a hypothetical sentence, the evaluation result aggregation section 204 may calculate, as the aggregate score, a statistic calculated from the entailment scores calculated for the respective plurality of hypothetical sentences. In this case, the evaluation result aggregation section 204 determines, on the basis of the calculated aggregate score, a classification as which the document is to be classified. Note that the statistic is a numerical value which has been obtained by application of a statistical algorithm and in which feature values of data are summed up.

This configuration brings about not only an example advantage brought about by the document classification apparatus 1 according to the first example embodiment but also an example advantage of making it possible to obtain a statistically appropriate evaluation result. For example, the evaluation result aggregation section 204 may calculate, as the aggregate score, an arithmetic mean value, a mode, a median, a maximum value, or a minimum value of the entailment scores calculated for the respective plurality of hypothetical sentences.

As described above, a configuration is employed such that the document classification apparatus 2 according to the present example embodiment includes: the hypothetical sentence generation section 202 that generates, for a candidate classification as which a document is to be classified, a plurality of hypothetical sentences, which are sentences related to the candidate classification; the entailment evaluation section 203 that subjects each of the plurality of hypothetical sentences to a process for evaluating whether the document to be classified entails a corresponding hypothetical sentence; and the evaluation result aggregation section 204 that determines, on the basis of a result of evaluation of each of the plurality of hypothetical sentences by the entailment evaluation section 203, a classification as which the document to be classified is to be classified. This configuration brings about an example advantage of making it possible to stably obtain a highly accurate evaluation result for appropriateness.

Note that the document to be classified need only be a character string having some meaning, and is not particularly limited in content, form, or language. Note also that a source of the document to be classified is also not particularly limited. For example, a character string extracted from, for example, a minutes of, for example, a meeting, a questionnaire result, or a post on, for example, a social networking service (SNS) may be used as the document to be classified. Alternatively, a document indicating speech content converted into text by voice recognition may be used as the document to be classified. Further alternatively, text extracted from a data source such as various databases may be used as it is as the document to be classified, or a premise sentence generated from the extracted text may be used as the document to be classified.

### (Generation Strategy)

A generation strategy is information for generating a hypothetical sentence related to a candidate classification. The generation strategy may be a hypothetical sentence template on the basis of which a hypothetical sentence is generated by incorporation of a character string of a candidate classification. The following description will discuss this with reference to FIG. 5. FIG. 5 is a view illustrating an example of the generation strategy.

A table illustrated in FIG. 5 includes generation strategies 1 to 3. Such information is stored in the generation strategy holding section 211. The generation strategy 1 is text data “This is a sentence concerning 1.”. A hypothetical sentence is generated by incorporating a character string of a candidate classification into the “1” part of this text data. Same applies to the generation strategies 2 and 3. By preparing such a generation strategy, the hypothetical sentence generation section 202 can easily generate a plurality of hypothetical sentences related to the candidate classification.

Note that a method of generating a hypothetical sentence is not limited to the above example. For example, the hypothetical sentence generation section 202 may generate a hypothetical sentence with use of a document generation model that outputs a document related to a character string by receiving an input of the character string. For example, an encoder-decoder model or the like can be applied to the document generation model. The encoder-decoder model that is applied here outputs a hypothetical sentence related to input text data by encoding the input text data (e.g., converting the input text data into a vector) and decoding data obtained by conversion (returning the data to text data).

### (Language Understanding Model)

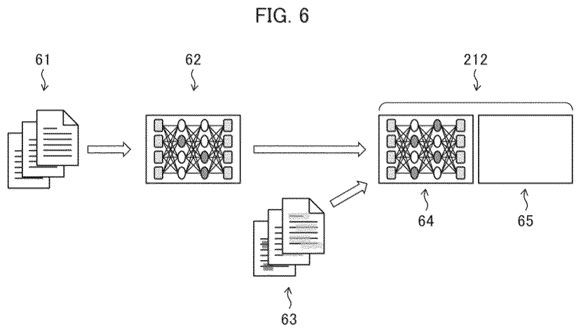

The language understanding model 212 is a model constructed so as to output an entailment score when a set of a hypothetical sentence and a document which set is to be evaluated is input, the entailment score being an index value indicating a degree to which the document entails the hypothetical sentence. The following description will discuss, with reference to FIG. 6, a method for generating the language understanding model 212. FIG. 6 is a view illustrating the method for generating the language understanding model 212.

The language understanding model 212 may be a combination of (i) a pretrained language model that converts a document into a vector which is in accordance with a context of the document and (ii) a language task model that classifies a document. In this case, a document to be classified and a hypothetical sentence are converted into respective vectors by the pretrained language model, and an entailment score indicating a degree to which the document to be classified entails the hypothetical sentence is calculated from these vectors by the language task model.

In a case where such a language understanding model 212 is generated, first, a pretrained language model 62 is generated from a large amount of text data 61, as illustrated in FIG. 6. A self-supervised learning method is preferably used to generate the pretrained language model 62. This makes it possible to, without labeling the text data with ground truth data, carry out learning for converting a document into a vector that is in accordance with a context of the document. For example, enormous text data on a web can be used as it is for learning.

Next, labeled training data 63 is used to generate a language task model 65 for classifying the vectors generated by the pretrained language model 62. Specifically, as the training data 63, it is only necessary to apply training data obtained by assigning, to a set of a hypothetical sentence and a document for which it is known whether the document entails the hypothetical sentence, a label indicating whether the document of the set entails the hypothetical sentence. Examples of the training data 63 that can be used include Stanford Natural Language Inference (SNLI) and Cross-lingual Natural Language Inference (XNLI).

This makes it possible to generate the language understanding model 212 that outputs an output value indicating, by, for example, a numerical value of 1 to 0, a degree to which an input document entails an input hypothetical sentence. As illustrated in FIG. 6, instead of using the pretrained language model 62 as it is, by using the training data 63 to tune the pretrained language model 62, it is possible to use a pretrained language model 64 with higher suitability to the language task model 65.

### (Evaluation in Consideration of Reliability)

The reliability calculation section 205 calculates reliability of a hypothetical sentence generation strategy. The reliability is a numerical value indicating appropriateness of a generation strategy. For example, the reliability calculation section 205 may apply a crowdsourcing method to calculate the reliability. More specifically, the reliability calculation section 205 may calculate, from correctness or incorrectness of a result obtained by using the generation strategies recorded in the generation strategy holding section 211 to carry out classification, the reliability of each of the generation strategies.

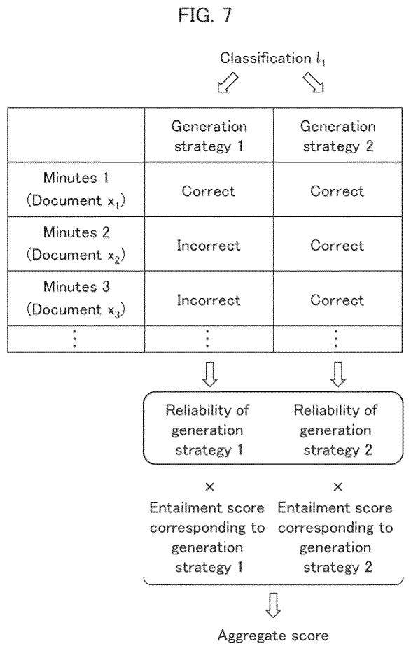

The following description will discuss this with reference to FIG. 7. FIG. 7 is a view illustrating examples of a method for calculating reliability of a generation strategy and a method for calculating an aggregate score with use of reliability. FIG. 7 illustrates a result obtained by using the generation strategies 1 and 2 to generate hypothetical sentences related to a classification 11, using the generated hypothetical sentences to classify a plurality of documents to be classified, and examining whether a result of the classification is correct or incorrect.

The documents to be classified include documents x₁ to X₃ extracted from respective data of minutes of a meeting (minutes 1 to 3). As illustrated in the drawing, in a case where the hypothetical sentence generated by the generation strategy 1 and related to the classification 1₁ is used, a classification result for the document x₁ is correct, but classification results for the documents x₂ and X₃ are incorrect. In contrast, in a case where the hypothetical sentence generated by the generation strategy 2 and related to the classification 1₁ is used, classification results for all the documents x₁ to x₃ are correct.

In a case where such history information indicating correctness or incorrectness of a classification result is recorded for various classifications 1, the reliability calculation section 205 can use the history information to calculate the reliability of each of the generation strategies for each of the classifications 1. Note that a user need only determine correctness or incorrectness of the classification result (entailment score).

For example, the reliability calculation section 205 may calculate an accuracy of each of the generation strategies from the history information and calculate the reliability that is in accordance with a degree of the accuracy. For example, in a case where the generation strategies 1 and 2 have respective accuracies of 30% and 70%, the reliability calculation section 205 may regard respective reliabilities of the generation strategies 1 and 2 as 0.3 and 0.7.

In a case where the reliability calculation section 205 calculates the reliability, the evaluation result aggregation section 204 considers a result of evaluation by the entailment evaluation section 203 in accordance with the reliability set for each of the plurality of generation strategies. For example, the evaluation result aggregation section 204 may use the reliability to weight the entailment score calculated by the entailment evaluation section 203, and calculate the entailment score as the aggregate score. Assume, for example, that, when the respective reliabilities of the generation strategies 1 and 2 are 0.3 and 0.7, entailment scores corresponding to the generation strategies 1 and 2 are 0.5 and 0.9, respectively. In this case, the evaluation result aggregation section 204 may calculate a value, i.e., 0.3×0.5+0.7×0.9=0.78 as the aggregate score.

As described above, the hypothetical sentence generation section 202 may generate a plurality of hypothetical sentences by respective different generation strategies. The evaluation result aggregation section 204 may determine, on the basis of a result of evaluation by the entailment evaluation section 203 and the reliability set for each of the plurality of generation strategies, a classification as which a document to be classified is to be classified. This configuration brings about not only the example advantage brought about by the document classification apparatus 1 according to the first example embodiment but also an example advantage of making it possible to obtain an appropriate evaluation result in which reliability of a hypothetical sentence generation strategy is reflected. Note that a process for determining a classification on the basis of an evaluation result and reliability is, in other words, a process for determining a classification by considering an evaluation result in accordance with reliability of the evaluation result.

### (Flow of Process)

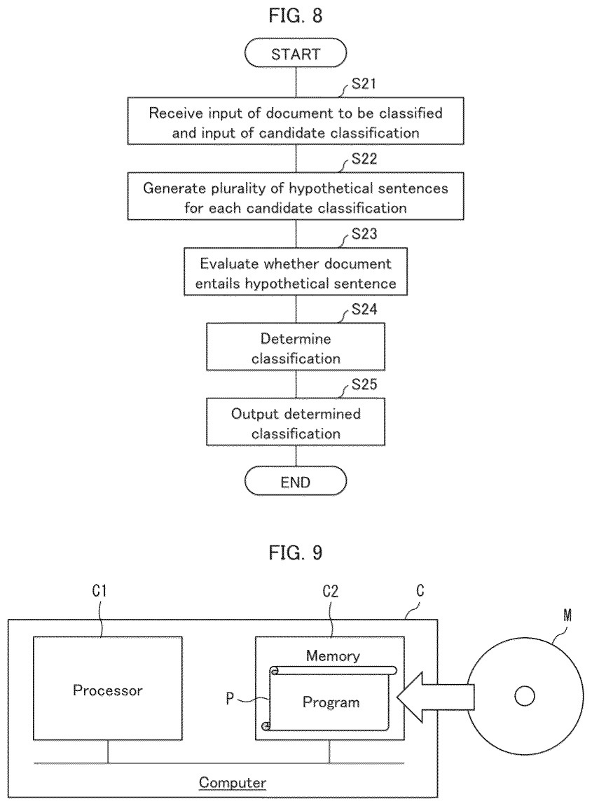

The following description will discuss, with reference to FIG. 8, a flow of a process (document classification method) carried out by the document classification apparatus 2. FIG. 8 is a flowchart showing the flow of the process carried out by the document classification apparatus 2.

In S21, the data acquisition section 201 receives an input of a document to be classified and an input of a candidate classification. Any text data can be applied as the document to be classified. One or more candidate classifications may be input. For example, the data acquisition section 201 may receive, as the candidate classification, an input of a label set L including a plurality of classification labels 1.

In S22, the hypothetical sentence generation section 202 generates, for each of the candidate classifications the input of which has been received in S21, a plurality of hypothetical sentences. For example, the generation strategies stored in the generation strategy holding section 211 may be used to generate the hypothetical sentences. For example, in a case where five labels 11 to 15 serve as candidate classifications and generation strategies are three generation strategies 1 to 3, three hypothetical sentences are generated for each of the labels 11 to 15. A total of 15 hypothetical sentences are generated in this case.

In S23, the entailment evaluation section 203 evaluates whether the document to be classified the input of which has been received in S21 entails a corresponding hypothetical sentence generated in S22. For example, the entailment evaluation section 203 may calculate an entailment score by inputting, into the language understanding model 212, a set of a hypothetical sentence and a document to be classified. This process is carried out with respect to each of the plurality of hypothetical sentences generated in S22. For example, in a case where a total of 15 hypothetical sentences are generated in S22, entailment scores are calculated for the respective hypothetical sentences, and a total of 15 entailment scores are calculated.

In S24, the evaluation result aggregation section 204 aggregates evaluation results in S23, and determines a classification as which the document to be classified the input of which has been received in S21 is to be classified. More specifically, the evaluation result aggregation section 204 determines, on the basis of a result of evaluation in S23, i.e., the entailment scores for the respective plurality of hypothetical sentences, a classification as which the document to be classified is to be classified. The classification as which the document to be classified is to be classified may be represented by, for example, the above-described aggregate score. This process is carried out with respect to each of the candidate classifications the input of which has been received in S21. For example, in a case where the five labels 11 to 15 serve as the candidate classifications, aggregate scores are calculated for the respective labels. Thus, a total of five aggregate scores are calculated. These aggregate scores indicate classifications as which the document to be classified is to be classified.

In a case where the reliability calculation section 205 calculates the reliability, in S24, the evaluation result aggregation section 204 calculates the aggregate score by considering the result of evaluation in S23 in accordance with the reliability set for each of the plurality of generation strategies. The reliability need only be calculated at any timing before calculation of the aggregate score.

In S25, the evaluation result aggregation section 204 causes the output section 23 to output the classification determined by the process in S24. For example, in a case where the five labels 11 to 15 serve as the candidate classifications and the aggregate score is calculated for each of the labels, the evaluation result aggregation section 204 may cause the output section 23 to output a label such that the calculated aggregate score exceeds a threshold. This ends the process in FIG. 8.

In S25, the evaluation result aggregation section 204 may output the aggregate score of each of the candidate classifications. In this case, from the output aggregate score, a user of the document classification apparatus 2 can determine, for example, as which of the candidate classifications a sentence to be classified is to be classified, or not to classify the sentence to be classified as any of the candidate classifications. As a matter of course, it is not always necessary to output any evaluation result or any classification. The evaluation result aggregation section 204 may store the calculated evaluation result and/or the determined classification in, for example, the storage section 21 so as to end the process.

### Variation

The processes described in the foregoing example embodiments may be carried out by any entity, which is not limited to the foregoing examples. That is, a document classification system having functions similar to the functions of the document classification apparatus 2 can be constructed by a plurality of apparatuses that can communicate with each other. For example, a document classification system having functions similar to the functions of the document classification apparatus 2 can be constructed by dispersedly providing, in a respective plurality of apparatuses, blocks illustrated in FIG. 4.

### Software Implementation Example

Some or all of the functions of the document classification apparatus 2 may be realized by hardware such as an integrated circuit (IC chip) or may be alternatively realized by software. In the latter case, the document classification apparatus 2 is realized by, for example, a computer that executes instructions of a program that is software realizing the foregoing functions. FIG. 9 illustrates an example of such a computer (hereinafter referred to as “computer C”). The computer C includes at least one processor C1 and at least one memory C2. The memory C2 stores a program P for causing the computer C to operate as the document classification apparatus 2. In the computer C, the functions of the document classification apparatus 2 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface via which the computer C transmits/receives data to/from another apparatus. The computer C may further include an input/output interface via which the computer C is connected to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can also be described as below. Note, however, that the present invention is not limited to the following supplementary notes.

### (Supplementary Note 1)

A document classification apparatus including: a hypothetical sentence generation means that generates, for a candidate classification as which a document is to be classified, a plurality of hypothetical sentences, which are sentences related to the candidate classification; an entailment evaluation means that subjects each of the plurality of hypothetical sentences to a process for evaluating whether the document entails a corresponding hypothetical sentence; and an evaluation result aggregation means that determines, on the basis of a result of evaluation of each of the plurality of hypothetical sentences by the entailment evaluation means, a classification as which the document is to be classified.

### (Supplementary Note 2)

The document classification apparatus according to Supplementary note 1, wherein the entailment evaluation means uses a language understanding model to calculate an index value indicating a degree to which the document entails the hypothetical sentence, the language understanding model having been constructed by learning whether a document entails a hypothetical sentence, and the evaluation result aggregation means determines, on the basis of a statistic calculated from the index value that has been calculated for each of the plurality of hypothetical sentences, the classification as which the document is to be classified.

### (Supplementary Note 3)

The document classification apparatus according to Supplementary note 1 or 2, wherein the hypothetical sentence generation means generates the plurality of hypothetical sentences by respective different generation strategies, and the evaluation result aggregation means determines, on the basis of the result of evaluation by the entailment evaluation means and reliability set for each of the plurality of generation strategies, the classification as which the document is to be classified.

### (Supplementary Note 4)

A document classification method including: (a) generating, for a candidate classification as which a document is to be classified, a plurality of hypothetical sentences, which are sentences related to the candidate classification; (b) subjecting each of the plurality of hypothetical sentences to a process for evaluating whether the document entails a corresponding hypothetical sentence; and (c) determining, on the basis of a result of evaluation of each of the plurality of hypothetical sentences, a classification as which the document is to be classified, (a), (b), and (c) each being carried out by at least one processor.

### (Supplementary Note 5)

A document classification program for causing a computer to function as: a hypothetical sentence generation means that generates, for a candidate classification as which a document is to be classified, a plurality of hypothetical sentences, which are sentences related to the candidate classification; an entailment evaluation means that subjects each of the plurality of hypothetical sentences to a process for evaluating whether the document entails a corresponding hypothetical sentence; and an evaluation result aggregation means that determines, on the basis of a result of evaluation of each of the plurality of hypothetical sentences by the entailment evaluation means, a classification as which the document is to be classified.

### Additional Remark 3

The whole or part of the example embodiments disclosed above further can also be expressed as below. A document classification apparatus including at least one processor, the at least one processor carrying out: a hypothetical sentence generation process for generating, for a candidate classification as which a document is to be classified, a plurality of hypothetical sentences, which are sentences related to the candidate classification; an entailment evaluation process for subjecting each of the plurality of hypothetical sentences to a process for evaluating whether the document entails a corresponding hypothetical sentence; and an evaluation result aggregation process for determining, on the basis of a result of evaluation of each of the plurality of hypothetical sentences by the entailment evaluation process, a classification as which the document is to be classified.

Note that the document classification apparatus may further include a memory, which may store a program for causing the at least one processor to carry out the hypothetical sentence generation process, the entailment evaluation process, and the evaluation result aggregation process. The program may be stored in a non-transitory tangible computer-readable storage medium.

### REFERENCE SIGNS LIST

1, 2 Document classification apparatus
11, 202: Hypothetical sentence generation section
12, 203 Entailment evaluation section
13, 204 Evaluation result aggregation section

What is claimed is:

1. A document classification apparatus comprising at least one processor, the processor carrying out:
a hypothetical sentence generation process for generating, for a candidate classification as which a document is to be classified, a plurality of hypothetical sentences, which are sentences related to the candidate classification;
an entailment evaluation process for subjecting each of the plurality of hypothetical sentences to a process for evaluating whether the document entails a corresponding hypothetical sentence; and
an evaluation result aggregation process for determining, on the basis of a result of evaluation of each of the plurality of hypothetical sentences by the entailment evaluation process, a classification as which the document is to be classified.

2. The document classification apparatus according to claim 1, wherein
in the entailment evaluation process, the at least one processor uses a language understanding model to calculate an index value indicating a degree to which the document entails the hypothetical sentence, the language understanding model having been constructed by learning whether a document entails a hypothetical sentence, and
in the evaluation result aggregation process, the at least one processor determines, on the basis of a statistic calculated from the index value that has been calculated for each of the plurality of hypothetical sentences, the classification as which the document is to be classified.

3. The document classification apparatus according to claim 1, wherein
in the hypothetical sentence generation process, the at least one processor generates the plurality of hypothetical sentences by respective different generation strategies, and
in the evaluation result aggregation process, the at least one processor determines, on the basis of the result of evaluation by the entailment evaluation process and reliability set for each of the plurality of generation strategies, the classification as which the document is to be classified.

4. A document classification method comprising:
(a) generating, for a candidate classification as which a document is to be classified, a plurality of hypothetical sentences, which are sentences related to the candidate classification;
(b) subjecting each of the plurality of hypothetical sentences to a process for evaluating whether the document entails a corresponding hypothetical sentence; and
(c) determining, on the basis of a result of evaluation of each of the plurality of hypothetical sentences, a classification as which the document is to be classified,
(a), (b), and (c) each being carried out by at least one processor.

5. A non-transitory storage medium storing a document classification program for causing a computer to carry out:
a hypothetical sentence generation process for generating, for a candidate classification as which a document is to be classified, a plurality of hypothetical sentences, which are sentences related to the candidate classification;
an entailment evaluation process for subjecting each of the plurality of hypothetical sentences to a process for evaluating whether the document entails a corresponding hypothetical sentence; and
an evaluation result aggregation process for determining, on the basis of a result of evaluation of each of the plurality of hypothetical sentences by the entailment evaluation process, a classification as which the document is to be classified.
